(19) United States
(12) Patent Application Publication
(10) Pub. No.: US 2018/0188563 A1
(43) Pub. Date: Jul. 5, 2018

(54) DISPLAY SUBSTRATE, LIQUID CRYSTAL DISPLAY PANEL, AND LIQUID CRYSTAL DISPLAY DEVICE

(71) Applicant: BOE TECHNOLOGY GROUP CO., LTD., Beijing (CN)

(72) Inventors: Jikai YAO, Beijing (CN); Yingtao WANG, Beijing (CN); Ken WEN, Beijing (CN); Xue DONG, Beijing (CN)

(73) Assignee: BOE TECHNOLOGY GROUP CO., LTD., Beijing (CN)

(21) Appl. No.: 15/821,100

(22) Filed: Nov. 22, 2017

(30) Foreign Application Priority Data
Jan. 3, 2017 (CN) 201710002815.7

(51) Int. Cl. G02F 1/1335

(52) U.S. Cl. CPC G02F 1/1336; G02F 1/133528; G02F 1/133512; G02F 2203/34; G02F 2202/36; G02F 2001/133614; G02F 2001/133548

(57) ABSTRACT

A display substrate, a liquid crystal display panel and a liquid crystal display device are provided. The display substrate includes a plurality of pixel units, where each pixel unit includes a first sub-pixel, a second sub-pixel and a third sub-pixel; the display substrate further includes: a base substrate, a pattern layer and a first polarizer arranged on the base substrate in sequence along a direction away from the base substrate; the pattern layer includes a first pattern in the first sub-pixel and a second pattern in the second sub-pixel, the first pattern is configured to emit first primary color light under an excitation of back light, and the second pattern is configured to emit second primary color light under the excitation of the back light; the third sub-pixel is configured to emit third primary color light under the excitation of the back light, or the third sub-pixel is configured to allow the back light to pass therethrough; and the first polarizer is a metallic wire grid polarizer.

### CROSS-REFERENCE TO RELATED APPLICATION

This application claims priority to Chinese Patent Application No. 201710002815.7 filed on Jan. 3, 2017, which is incorporated herein by reference in its entirety.

### TECHNICAL FIELD

The present disclosure relates to the field of display technology, and in particular to a display substrate, a liquid crystal display panel and a liquid crystal display device.

### BACKGROUND

At present, the liquid crystal display (LCD) has been widely applied as having small power consumption, a small size and being light and thin.

Along with a rapid development of the display technology, customers have increasingly requirements for the display product, e.g., the customers require a higher light-emitting efficiency. However, in the related art, light of only certain wavebands may pass through a color photoresist layer, so an intensity of the light passed through the color photoresist layer may be reduced. As a result, the light-emitting efficiency of the liquid crystal display device in the related art is relative low, and a display effect thereof is adversely affected.

### SUMMARY

The present disclosure provides a display substrate, a liquid crystal display panel and a liquid crystal display device, so as to light-emitting efficiency of the liquid crystal display device.

A display substrate is provided, including a plurality of pixel units, where each pixel unit includes a first sub-pixel, a second sub-pixel and a third sub-pixel; the display substrate further includes: a base substrate, a pattern layer and a first polarizer arranged on the base substrate in sequence along a direction away from the base substrate; the pattern layer includes a first pattern in the first sub-pixel and a second pattern in the second sub-pixel, the first pattern is configured to emit first primary color light under an excitation of back light, and the second pattern is configured to emit second primary color light under the excitation of the back light; the third sub-pixel is configured to emit third primary color light under the excitation of the back light, or the third sub-pixel is configured to allow the back light to pass therethrough; and the first polarizer is a metallic wire grid polarizer.

Optionally, the first pattern is a red quantum dot pattern, the second pattern is a green quantum dot pattern, and the back light is blue light; and the pattern layer further includes a third pattern made of a transparent material and configured to scatter the back light.

Optionally, the display substrate further includes an array layer.

Optionally, the array layer is arranged at a side of the first polarizer away from the base substrate, or the array layer is arranged between the pattern layer and the base substrate.

Optionally, the display substrate further includes a pixel definition region and a light shielding pattern in the pixel definition region, where the light shielding pattern is at a layer identical to the pattern layer.

Optionally, the metallic wire grid polarizer includes a plurality of metallic wire grid sub-polarizers arranged in a stacked manner; refractive indexes of the metallic wire grid sub-polarizers decrease gradually along a light-exiting direction of the display substrate.

Optionally, the metallic wire grid polarizer includes three layers of metallic wire grid sub-polarizers arranged in a stacked manner; the three layers of metallic wire grid sub-polarizers arranged along a light-exiting direction of the display substrate are made of Al, SiO₂, FeSi₂ respectively.

Optionally, the display substrate further includes a planarization layer between the pattern layer and the first polarizer.

Optionally, the light shielding pattern and the pattern layer are arranged on an upper surface of the base substrate; an extension distance of the light shielding pattern from the upper surface of the base substrate is identical to an extension distance of the pattern layer from the upper surface of the base substrate; and an orthogonal projection of the light shielding pattern onto the base substrate does not overlap an orthogonal projection of the pattern layer onto the base substrate.

A liquid crystal display panel is further provided, including the display substrate hereinabove and an opposite substrate, and the opposite substrate includes a second polarizer.

Optionally, the second polarizer is a metallic wire grid polarizer.

A liquid crystal display device is further provided, including the liquid crystal display panel hereinabove and a backlight source.

A liquid crystal display device is further provided, including a liquid crystal display panel and a backlight source, where the liquid crystal display panel includes a display substrate and an opposite substrate; the display substrate includes a plurality of pixel units, where each pixel unit includes a first sub-pixel, a second sub-pixel and a third sub-pixel; the display substrate further includes: a base substrate, a pattern layer and a first polarizer arranged on the base substrate in sequence along a direction away from the base substrate; the pattern layer includes a first pattern in the first sub-pixel, a second pattern in the second sub-pixel and a third pattern in the third sub-pixel; the first pattern is configured to emit first primary color light under an excitation of back light emitted by the backlight source, the second pattern is configured to emit second primary color light under the excitation of the back light emitted by the backlight source, and the third sub-pixel is configured to emit third primary color light under the excitation of the back light emitted by the backlight source; and the first polarizer is a metallic wire grid polarizer.

Optionally, the first pattern is a quantum dot pattern of the first primary color light, the second pattern is a quantum dot pattern of the second primary color light, and the third pattern is a quantum dot pattern of the third primary color light; and a wavelength of the back light emitted by the backlight source is smaller than wavelengths of the first primary color light, the second primary color light and the third primary color light.

A liquid crystal display device is further provided, including a liquid crystal display panel and a backlight source, where the liquid crystal display panel includes a display substrate and an opposite substrate; the display substrate includes a plurality of pixel units, where each pixel unit includes a first sub-pixel, a second sub-pixel and a third sub-pixel; the display substrate further includes: a base substrate, a pattern layer and a first polarizer arranged on the base substrate in sequence along a direction away from the base substrate; the pattern layer includes a first pattern in the first sub-pixel and a second pattern in the second sub-pixel; the first pattern is configured to emit first primary color light under an excitation of back light emitted by the backlight source, and the second pattern is configured to emit second primary color light under the excitation of the back light emitted by the backlight source, and the third sub-pixel is configured to allow the back light emitted by the backlight source to pass therethrough; and the first polarizer is a metallic wire grid polarizer.

Optionally, the pattern layer further includes a third pattern in the third sub-pixel; the third pattern is made of a transparent material and configured to scatter the back light emitted by the backlight source.

Optionally, the first pattern is a quantum dot pattern of the first primary color light, and the second pattern is a quantum dot pattern of the second primary color light; and a wavelength of the back light emitted by the backlight source is smaller than wavelengths of the first primary color light and the second primary color light.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1(a) is a schematic view of a display substrate in at least one embodiment of the present disclosure;

FIG. 1(b) is a schematic view of a display substrate in at least one embodiment of the present disclosure;

FIG. 2(a) is a schematic view of a display substrate in at least one embodiment of the present disclosure;

FIG. 2(b) is a schematic view of a display substrate in at least one embodiment of the present disclosure;

FIG. 2(c) is a schematic view of a display substrate in at least one embodiment of the present disclosure;

FIG. 3 is a schematic view of a display substrate in at least one embodiment of the present disclosure;

FIG. 4 is a schematic view of a metallic wire grid polarizer in at least one embodiment of the present disclosure;

FIG. 5 is a schematic view of a display substrate in at least one embodiment of the present disclosure;

FIG. 6(a) is a schematic view of a liquid crystal display panel in at least one embodiment of the present disclosure;

FIG. 6(b) is a schematic view of a liquid crystal display panel in at least one embodiment of the present disclosure;

FIG. 6(c) is a schematic view of a liquid crystal display panel in at least one embodiment of the present disclosure;

FIG. 6(d) is a schematic view of a liquid crystal display panel in at least one embodiment of the present disclosure; and

FIG. 7 is a schematic view of a liquid crystal display device in at least one embodiment of the present disclosure.

### DRAWING REFERENCE

01—display substrate; 02—opposite substrate; 03—liquid crystal display panel; 04—backlight source; 10—base substrate; 20—pattern layer; 201—first pattern; 202—second pattern; 203—third pattern; 30—first polarizer; 40—array layer; 401—thin film transistor; 402—pixel electrode; 50—insulation layer; 60—light shielding pattern; 70—planarization layer; 80—second polarizer; 90—substrate; 100—liquid crystal layer; 110—alignment layer

### DETAILED DESCRIPTION

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

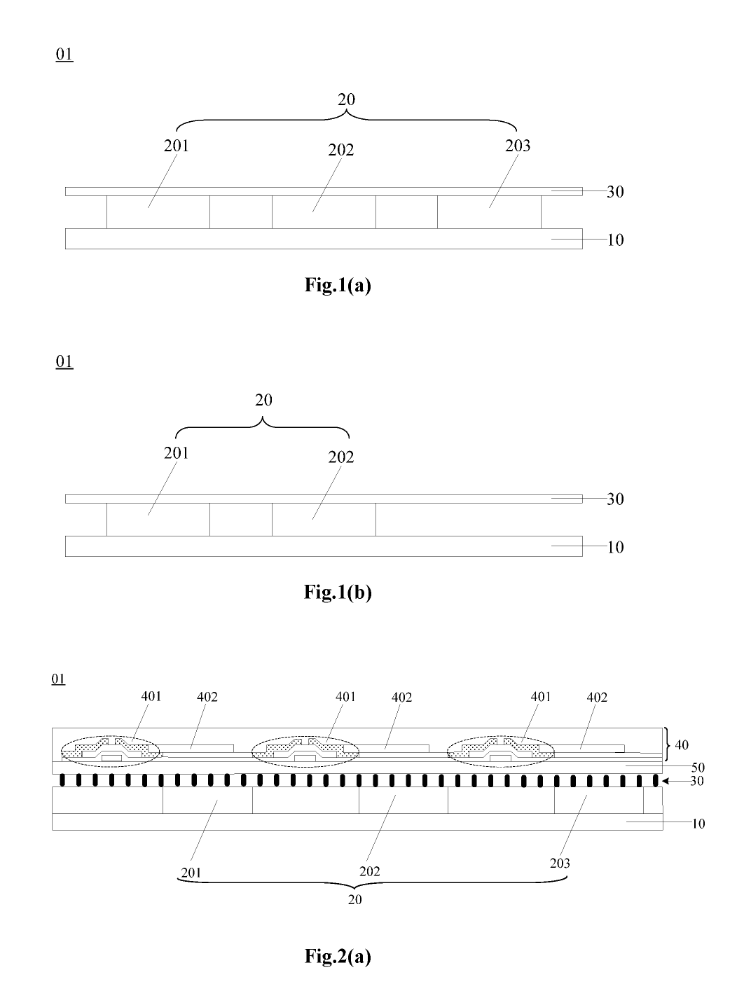

The present disclosure provides in at least one embodiment a display substrate 01. The display substrate 01 includes a plurality of pixel units, where each pixel unit includes a first sub-pixel, a second sub-pixel and a third sub-pixel. As shown in FIG. 1(a) and FIG. 1(b), the display substrate further includes: a base substrate 10, a pattern layer 20 and a first polarizer 30 arranged on the base substrate 10 in sequence along a direction away from the base substrate 10. The pattern layer 20 includes a first pattern 201 in the first sub-pixel and a second pattern 202 in the second sub-pixel, the first pattern 201 is configured to emit first primary color light under an excitation of back light, and the second pattern 202 is configured to emit second primary color light under the excitation of the back light. The third sub-pixel is configured to emit third primary color light under the excitation of the back light, or the third sub-pixel is configured to allow the back light which is the third primary color light to pass therethrough. The first polarizer 30 is a metallic wire grid polarizer (WGP).

It should be noted that, firstly, the first primary color light, the second primary color light and the third primary color light are three-primary colors, e.g., red light, green light and blue light, or cyan light, magenta light and yellow light.

Secondly, when the third sub-pixel is configured to emit the third primary color light under the excitation of the back light, as shown in FIG. 1(a), the pattern layer 20 further includes a third pattern 203 arranged in the third sub-pixel and configured to emit the third primary color light under the excitation of the back light.

It should be appreciated by those skilled in the art that, light with a relatively short wavelength may excite a material to emit light with a wavelength longer that of the light with the relatively short wavelength. When the first primary color light, the second primary color light and the third primary color light are red light, green light and blue light respectively, it is able to use laser or blue-purple light to excite the first pattern 201, the second pattern 202 and the third pattern 203 to emit red light, green light and blue light respectively.

When the third sub-pixel is configured to allow the back light which is the third primary color light to pass therethrough, as shown in FIG. 1(a), the third pattern 203 may be arranged in the third sub-pixel and made of a transparent material, or as shown in FIG. 1(b), the back light may pass through the third sub-pixel directly, so there is no need to arrange other transparent patterns in the third sub-pixel.

As light with a relatively short wavelength may excite a material to emit light with a wavelength longer that of the light with the relatively short wavelength, the third primary color light with a relatively short wavelength may excite the first pattern 201 and the second pattern 202 to respectively emit the first primary color light and the second primary color light each having a wavelength longer that of the third primary color light. For example, the back light is blue light, the first pattern 201 emits red light under an excitation of blue light, and the second pattern 202 emits green light under the excitation of the blue light.

Thirdly, materials of the first pattern 201 and the second pattern 202 are not limited, e.g., the materials may be an organic electroluminescent material or a quantum dot light-emitting material. When the pattern layer includes the third pattern 203 configured to emit the third primary color light under the excitation of the back light, the third pattern 203 may be made of an organic electroluminescent material or a quantum dot light-emitting material.

Fourthly, the metallic wire grid polarizer consists of wire grids arranged at intervals and parallel to each other. Electrons in the wire grids may only move along the wire grids. When light beams irradiate the wire grid, a vibration of a photoelectric vector along the wire grid may be absorbed by the electrons in the wire grid, and the electric vector perpendicular to the wire grid may pass through, such that only the photons along a longitudinal direction may be absorbed while the photons along a transverse direction may be not absorbed, thereby achieving linearly polarized light.

Here, a width and a thickness of each metallic wire grid in the metallic wire grid polarizer and an interval between wire grids therein are not limited, which may be arranged as needed. Optionally, the width of each wire grid is from 20 nm to 100 nm, the thickness of each wire grid is from 50 nm to 400 nm, and the interval between the wire grids is from 20 nm to 100 nm.

According to the display substrate 01 in at least one embodiment of the present disclosure, the first pattern 201 may emit the first primary color light under an excitation of back light, the second pattern 202 may emit the second primary color light under the excitation of the back light, and the third sub-pixel may emit the third primary color light under the excitation of the back light, or the third sub-pixel may allow the third primary color light emitted by the backlight source to pass therethrough. Therefore, when the back light passes through the first, the second and the third sub-pixels, light of every wavebands may not be blocked. Therefore, in compared with prior art where light of only certain wavebands may pass through, light-emitting efficiency of the display substrate 01 in at least one embodiment of the present disclosure may be improved.

Optionally, as shown in FIG. 1(a), the first pattern 201 is a red quantum dot pattern, the second pattern 202 is a green quantum dot pattern, and the back light is blue light; and the pattern layer 20 further includes a third pattern 203 made of a transparent material and configured to scatter the back light.

Here, the transparent material may be a material capable of scattering light, or the transparent material may consist of a base material doped with a nanometer material capable of scattering light. The base material may be an organic or inorganic material. When the base material is an organic material, it may be a resin.

The red quantum dot pattern may emit red light under the excitation of light with a wavelength smaller than the red light, and green quantum dot pattern may emit green light under the excitation of light with a wavelength smaller than the green light, therefore blue light may excite the red quantum dot pattern to emit red light and excite the green quantum dot pattern to emit green light.

It should be noted that, since the red light and the green light emitted respectively by the red quantum dot pattern and the green quantum dot pattern are scattered, in the case that the material only allows blue light to pass through without scattering the same, the red light emitted by the first sub-pixel and the green light emitted by the second sub-pixel each may be diverged by a relatively large divergent angle, and the blue light passing through the third sub-pixel may be diverged by a relatively small divergent angle. As a result, colors of the light emitted by the display substrate 01 may be adversely affected. Therefore, in at least one embodiment of the present disclosure, the transparent material is capable of scattering the light.

In at least one embodiment of the present disclosure, the light emitted by the quantum dot light-emitting material after the quantum dot light-emitting material is excited may have a large color gamut range. Therefore, in the case that the first pattern 201 is a red quantum dot pattern and the second pattern 202 is a green quantum dot pattern, the color gamut range of the display substrate 01 may be increased. Based on this, the material of the third pattern 203 is capable of scattering light and the first pattern 201 and the second pattern 202 may emit light after being excited, therefore a viewing angle range of the display substrate 01 may be increased.

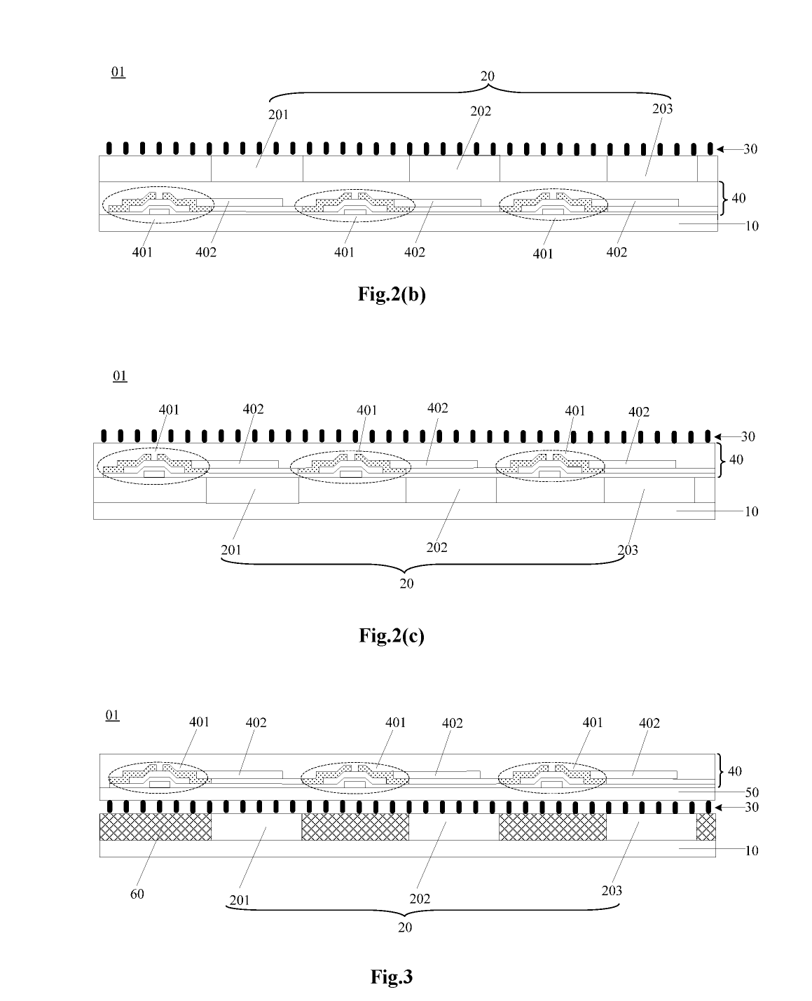

Optionally, as shown in FIG. 2(a), FIG. 2(b) and FIG. 2(c), the display substrate 01 further includes an array layer 40.

Here, the array layer 40 may be an array layer in the related art. The array layer 40 includes a thin film transistor 401 and a pixel electrode 402. The thin film transistor 401 includes a source electrode, a drain electrode, an active layer, a gate electrode and a gate insulation layer. The pixel electrode 402 is electrically connected to the drain electrode. Based on this, the display substrate may further include a common electrode (not shown in the drawings) arranged at a layer identical to or different from the pixel electrode, which is not limited herein.

The position of the array layer 40 is not limited. For example, as shown in FIG. 2(a), the array layer 40 is arranged at a side of the first polarizer 30 away from the base substrate 10, or as shown in FIG. 2(b), the array layer 40 is arranged between the pattern layer 20 and the base substrate 10, or as shown in FIG. 2(c), the array layer 40 is arranged between the pattern layer 20 and the first polarizer 30.

It should be noted that, the drawings of the present disclosure only show some parts of the display substrate.

It should be appreciated by those skilled in the art, when the array layer 40 is arranged at a side of the first polarizer 30 away from the base substrate 10, since the first polarizer 30 is a metallic wire grid polarizer, an insulation layer 50 should be arranged on the metallic wire grid polarizer firstly, and then the array layer 40 may be arranged on the insulation layer 50.

In at least one embodiment of the present disclosure, the display substrate 01 may include both the array layer 40 and the pattern layer 20.

The first polarizer 30 is a metallic wire grid polarizer, while a metallic material may adversely affect the electrodes (the pixel electrode 402 and/or the common electrode) in the array layer 40. Therefore, in at least one embodiment of the present disclosure, the first polarizer 30 is not arranged on the array layer 40, that is, the array layer 40 is not arranged between the pattern layer 20 and the first polarizer 30.

In at least one embodiment of the present disclosure, as shown in FIG. 2(a), the array layer 40 is arranged at a side of the first polarizer 30 away from the base substrate 10, or as shown in FIG. 2(b), the array layer 40 is arranged between the pattern layer 20 and the base substrate 10.

It should be noted that, in the case that the array layer 40 is arranged at a side of the first polarizer 30 away from the base substrate 10, when forming the display substrate 01, the pattern layer 20 is formed firstly and then the array layer 40 is formed. In the case that the first pattern 201 is a red quantum dot pattern and the second pattern 202 is a green quantum dot pattern, and the array layer 40 is formed through a high-temperature process, a property of the quantum dot may be damaged. Therefore, in order to protect the property of the quantum dot from being damaged by the high temperature, the array layer 40 may be formed through a low-temperature process.

Optionally, as shown in FIG. 3, the display substrate 01 includes a pixel definition region configured to define the sub-pixels and a light shielding pattern 60 in the pixel definition region. The light shielding pattern 60 is at a layer identical to the pattern layer 20.

Here, the pixel definition region refers to a light-shielding region of the display substrate 01.

A material of the light shielding pattern 60 is not limited, for example, the light shielding pattern 60 may be made of a black resin.

It should be noted that, the light shielding pattern 60 is at a layer identical to the pattern layer 20, refers to that the light shielding pattern 60 and the pattern layer 20 are arranged on an identical bearing plane.

According to the display substrate in at least one embodiment of the present disclosure, both the light shielding pattern 60 and the pattern layer 20 are arranged on the base substrate and at an identical layer, thereby reducing a thickness of the display substrate 01.

In at least one embodiment of the present disclosure, as shown in FIG. 4, the light shielding pattern 60 and the pattern layer 20 are arranged on an upper surface of the base substrate 10. An extension distance of the light shielding pattern 60 from the upper surface of the base substrate 10 is identical to an extension distance of the pattern layer 20 from the upper surface of the base substrate 10, and an orthogonal projection of the light shielding pattern 60 onto the base substrate 10 does not overlap orthogonal projections of the first pattern 201, the second pattern 202 and the third pattern 203 onto the base substrate.

Optionally, as shown in FIG. 4, the metallic wire grid polarizer includes a plurality of metallic wire grid sub-polarizers arranged in a stacked manner, and refractive indexes of the metallic wire grid sub-polarizers decrease gradually along a light-exiting direction of the display substrate 01.

The number of layers of the metallic wire grid sub-polarizers of each metallic wire grid polarizer is not limited, i.e., there may be two or more layers of metallic wire grid sub-polarizers.

It should be noted that, as an example, in FIG. 4, the metallic wire grid polarizer is directly arranged on the pattern layer 20, however the present disclosure is not limited herein.

Here, the metallic wire grid sub-polarizers arranged in a stacked manner, which refers to that orthogonal projections of every layers of the metallic wire grid sub-polarizer onto the base substrate 10 overlaps along a direction perpendicular to the base substrate 10.

Optionally, the metallic wire grid sub-polarizers arranged along a light-exiting direction of the display substrate 01 are made of mixtures of Al, SiO₂, Ti respectively. Between the mixture of the SiO₂ and the mixture of Ti, a refractive index of Ti is larger. Therefore, a proportion of the mixture of Ti may decrease gradually along the light-exiting direction of the display substrate 01.

According to the display substrate in at least one embodiment of the present disclosure, the refractive indexes of the metallic wire grid sub-polarizers decrease gradually along the light-exiting direction of the display substrate 01, therefore a difference between the refractive index of the metallic wire grid sub-polarizer and a refractive index of air decreases gradually, therefore reducing the reflection of the ambient light by the metallic wire grid polarizer and increasing the contrast ratio.

Optionally, the metallic wire grid polarizer includes three layers of metallic wire grid sub-polarizers arranged in a stacked manner, and the three layers of metallic wire grid sub-polarizers arranged along a light-exiting direction of the display substrate 01 are made of Al, SiO₂, FeSi₂ respectively.

According to the display substrate in at least one embodiment of the present disclosure, the metallic wire grid sub-polarizers arranged along the light-exiting direction of the display substrate 01 are made of Al, SiO₂, FeSi₂ respectively, thereby reducing the reflection of the ambient light by the metallic wire grid polarizer and increasing the contrast ratio.

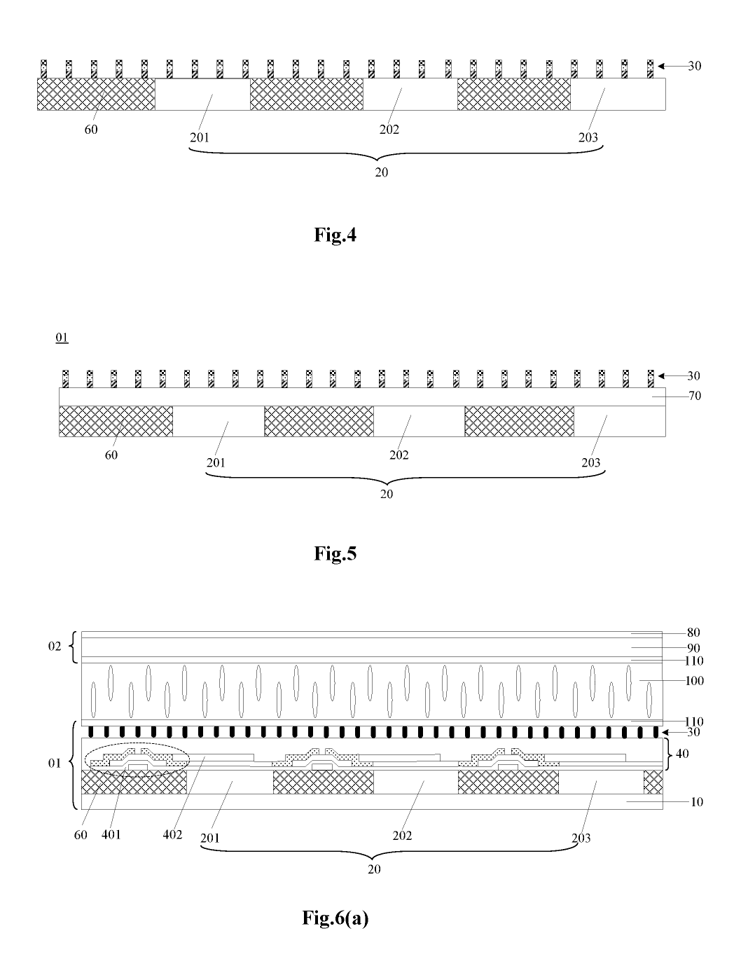

When forming the pattern layer 20, a surface of the pattern layer 20 is commonly not smooth, and in the case that the first polarizer 30 is directly formed on the pattern layer 20, the first polarizer 30 may not be smooth accordingly. As a result, a property of the first polarizer 30 may be adversely affected. Optionally, as shown in FIG. 5, the display substrate 01 further includes a planarization layer 70 between the pattern layer 20 and the first polarizer 30.

A material of the planarization layer 70 is not limited, which may be any transparent material.

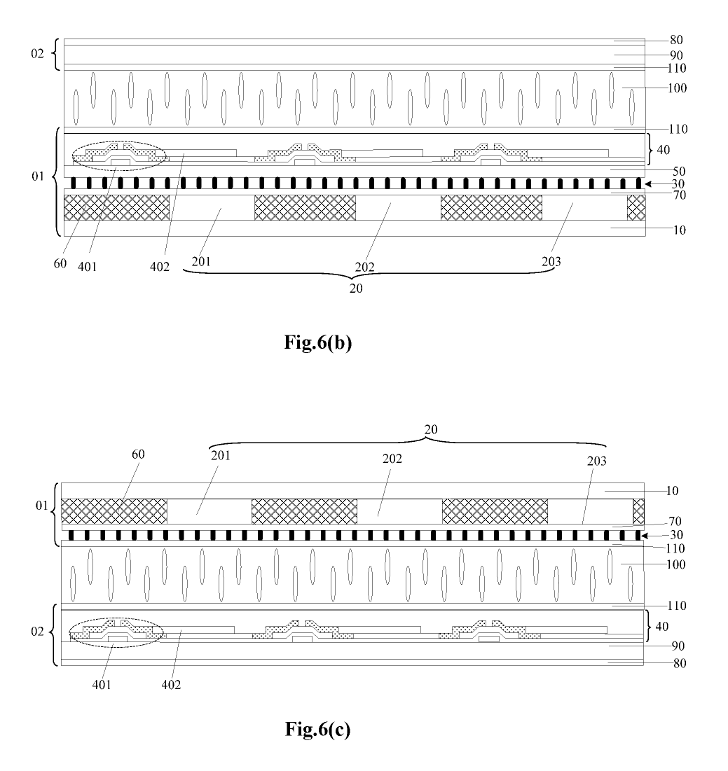

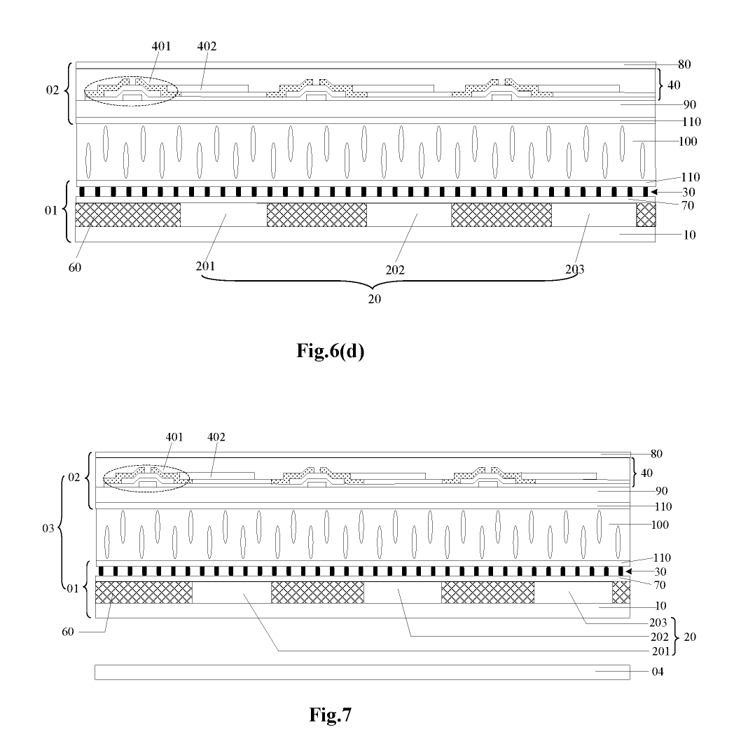

A liquid crystal display panel is further provided in at least one embodiment of the present disclosure. As shown in FIG. 6(a), FIG. 6(b), FIG. 6(c) and FIG. 6(d), the liquid crystal display panel includes the display substrate 01 hereinabove and an opposite substrate 02, and the opposite substrate 02 includes a second polarizer 80.

A structure of the second polarizer 80 is not limited, which may be a common polarizer in the related art or a metallic wire grid polarizer. In addition, it should be appreciated by those skilled in the art, a light-transmitting axle of the first polarizer 30 is perpendicular to a light-transmitting axle of the second polarizer 80.

Here, the opposite substrate 02 further includes a substrate 90, and the second polarizer 80 is arranged on the substrate 90. In addition, the liquid crystal display panel further includes a liquid crystal layer 100 between the display substrate 01 and the opposite substrate 02 and alignment layers 110 arranged at two sides of the liquid crystal layer 100.

It should be noted that, the array layer 40 and the pattern layer 20 may be arranged at an identical side of the liquid crystal layer 100, as shown in FIG. 6(a) and FIG. 6(b), i.e., the array layer 40 and the pattern layer 20 are arranged on an identical base substrate 10, or as shown in FIG. 6(c) and FIG. 6(d), the array layer 40 and the pattern layer 20 are arranged different sides of the liquid crystal layer 100, i.e., the array layer 40 and the pattern layer 20 are arranged at different base substrates.

According to the liquid crystal display panel in at least one embodiment of the present disclosure, the first pattern 201 may emit the first primary color light under an excitation of back light, the second pattern 202 may emit the second primary color light under the excitation of the back light, and the third sub-pixel may emit the third primary color light under the excitation of the back light, or the third sub-pixel may allow the third primary color light emitted by the backlight source to pass therethrough. Therefore, when the back light passes through the first, the second and the third sub-pixels, light of every wavebands may not be blocked. Therefore, in compared with prior art where light of only certain wavebands may pass through, light-emitting efficiency of the display substrate in at least one embodiment of the present disclosure may be improved.

Optionally, the second polarizer 80 is a metallic wire grid polarizer.

A structure of the second polarizer 80 is not limited. The structure of the second polarizer 80 may be identical to or different from the first polarizer 30.

It should be noted that, the second polarizer 80 is a metallic wire grid polarizer, so the second polarizer 80 should be arranged at a side of the substrate 90 close to the liquid crystal layer 100.

In at least one embodiment of the present disclosure, the metallic wire grid polarizer may achieve an optimal polarizing property, so the second polarizer 80 may be a metallic wire grid polarizer.

A liquid crystal display device is further provided in at least one embodiment of the present disclosure. As shown in FIG. 7, the liquid crystal display device includes the liquid crystal display panel 03 hereinabove and a backlight source 04.

A structure of the liquid crystal display panel 03 is not limited, which may be a structure as shown in FIG. 6(a)-FIG. 6(b). For example, the liquid crystal display panel 03 in FIG. 7 may be the liquid crystal display panel shown in FIG. 6(d).

It should be noted that, in the case that the third sub-pixel is configured to emit the third primary color light under the excitation of the back light emitted by the backlight source 04, the back light emitted by the backlight source 04 may be blue-purple light, laser or light with a wavelength smaller than blue-purple light. In the case that the third sub-pixel is configured to allow the back light emitted by the backlight source 04 to pass therethrough, the back light emitted by the backlight source 04 may be blue light.

According to the liquid crystal display device in at least one embodiment of the present disclosure, the first pattern 201 may emit the first primary color light under an excitation of back light, the second pattern 202 may emit the second primary color light under the excitation of the back light, and the third sub-pixel may emit the third primary color light under the excitation of the back light, or the third sub-pixel may allow the third primary color light emitted by the backlight source to pass therethrough. Therefore, when the back light passes through the first, the second and the third sub-pixels, light of every wavebands may not be blocked. Therefore, in compared with prior art where light of only certain wavebands may pass through, light-emitting efficiency of the display substrate in at least one embodiment of the present disclosure may be improved.

The above are merely the preferred embodiments of the present disclosure. A person skilled in the art may make further modifications and improvements without departing from the principle of the present disclosure, and these modifications and improvements shall also fall within the scope of the present disclosure.

What is claimed is:

1. A display substrate, comprising a plurality of pixel units, wherein each pixel unit comprises a first sub-pixel, a second sub-pixel and a third sub-pixel;
the display substrate further comprises: a base substrate, a pattern layer and a first polarizer arranged on the base substrate in sequence along a direction away from the base substrate;
the pattern layer comprises a first pattern in the first sub-pixel and a second pattern in the second sub-pixel, the first pattern is configured to emit first primary color light under an excitation of back light, and the second pattern is configured to emit second primary color light under the excitation of the back light;
the third sub-pixel is configured to emit third primary color light under the excitation of the back light, or the third sub-pixel is configured to allow the back light to pass therethrough; and
the first polarizer is a metallic wire grid polarizer.

2. The display substrate according to claim 1, wherein the first pattern is a red quantum dot pattern, the second pattern is a green quantum dot pattern, and the back light is blue light; and
the pattern layer further comprises a third pattern made of a transparent material and configured to scatter the back light.

3. The display substrate according to claim 1, further comprising an array layer.

4. The display substrate according to claim 3, wherein the array layer is arranged at a side of the first polarizer away from the base substrate, or the array layer is arranged between the pattern layer and the base substrate.

5. The display substrate according to claim 1, further comprising a pixel definition region and a light shielding pattern in the pixel definition region, wherein the light shielding pattern is at a layer identical to the pattern layer.

6. The display substrate according to claim 1, wherein the metallic wire grid polarizer comprises a plurality of metallic wire grid sub-polarizers arranged in a stacked manner;
refractive indexes of the metallic wire grid sub-polarizers decrease gradually along a light-exiting direction of the display substrate.

7. The display substrate according to claim 1, wherein the metallic wire grid polarizer comprises three layers of metallic wire grid sub-polarizers arranged in a stacked manner;
the three layers of metallic wire grid sub-polarizers arranged along a light-exiting direction of the display substrate are made of Al, SiO₂, FeSi₂ respectively.

8. The display substrate according to claim 1, further comprising a planarization layer between the pattern layer and the first polarizer.

9. The display substrate according to claim 5, wherein the light shielding pattern and the pattern layer are arranged on an upper surface of the base substrate;
an extension distance of the light shielding pattern from the upper surface of the base substrate is identical to an extension distance of the pattern layer from the upper surface of the base substrate; and
an orthogonal projection of the light shielding pattern onto the base substrate does not overlap an orthogonal projection of the pattern layer onto the base substrate.

10. A liquid crystal display panel, comprising the display substrate according to claim 1 and an opposite substrate;
wherein the opposite substrate comprises a second polarizer.

11. The liquid crystal display panel according to claim 10, wherein the second polarizer is a metallic wire grid polarizer.

12. A liquid crystal display device, comprising the liquid crystal display panel according to claim 10 and a backlight source.

13. A liquid crystal display device, comprising a liquid crystal display panel and a backlight source, wherein the liquid crystal display panel comprises a display substrate and an opposite substrate;
the display substrate comprises a plurality of pixel units, wherein each pixel unit comprises a first sub-pixel, a second sub-pixel and a third sub-pixel;
the display substrate further comprises: a base substrate, a pattern layer and a first polarizer arranged on the base substrate in sequence along a direction away from the base substrate;
the pattern layer comprises a first pattern in the first sub-pixel, a second pattern in the second sub-pixel and a third pattern in the third sub-pixel;
the first pattern is configured to emit first primary color light under an excitation of back light emitted by the backlight source, the second pattern is configured to emit second primary color light under the excitation of the back light emitted by the backlight source, and the third sub-pixel is configured to emit third primary color light under the excitation of the back light emitted by the backlight source; and
the first polarizer is a metallic wire grid polarizer.

14. The liquid crystal display device according to claim 13, wherein the first pattern is a quantum dot pattern of the first primary color light, the second pattern is a quantum dot pattern of the second primary color light, and the third pattern is a quantum dot pattern of the third primary color light; and
a wavelength of the back light emitted by the backlight source is smaller than wavelengths of the first primary color light, the second primary color light and the third primary color light.

15. A liquid crystal display device, comprising a liquid crystal display panel and a backlight source, wherein the liquid crystal display panel comprises a display substrate and an opposite substrate;
the display substrate comprises a plurality of pixel units, wherein each pixel unit comprises a first sub-pixel, a second sub-pixel and a third sub-pixel;
the display substrate further comprises: a base substrate, a pattern layer and a first polarizer arranged on the base substrate in sequence along a direction away from the base substrate;
the pattern layer comprises a first pattern in the first sub-pixel and a second pattern in the second sub-pixel;
the first pattern is configured to emit first primary color light under an excitation of back light emitted by the backlight source, and the second pattern is configured to emit second primary color light under the excitation of the back light emitted by the backlight source, and the third sub-pixel is configured to allow the back light emitted by the backlight source to pass therethrough; and
the first polarizer is a metallic wire grid polarizer.

16. The liquid crystal display device according to claim 15, wherein the pattern layer further comprises a third pattern in the third sub-pixel;
the third pattern is made of a transparent material and configured to scatter the back light emitted by the backlight source.

17. The liquid crystal display device according to claim 16, wherein the first pattern is a quantum dot pattern of the first primary color light, and the second pattern is a quantum dot pattern of the second primary color light; and
a wavelength of the back light emitted by the backlight source is smaller than wavelengths of the first primary color light and the second primary color light.

18. A liquid crystal display panel, comprising the display substrate according to claim 2 and an opposite substrate;
wherein the opposite substrate comprises a second polarizer.

19. A liquid crystal display panel, comprising the display substrate according to claim 3 and an opposite substrate;
wherein the opposite substrate comprises a second polarizer.

20. A liquid crystal display panel, comprising the display substrate according to claim 4 and an opposite substrate;
wherein the opposite substrate comprises a second polarizer.
